(19) United States
(12) Patent Application Publication
(10) Pub. No.: US 2004/0178178 A1
(43) Pub. Date: Sep. 16, 2004

(54) Continuous surface preparation of metals

(76) Inventors: Kay Y. Blohowiak, Issaquah, WA (US); Robert A. Anderson, Federal Way, WA (US); Shane E. Arthur, Enumclaw, WA (US); William B. H. Grace, Seattle, WA (US); Darrin M. Hansen, Seattle, WA (US); Steven R. Jones, Sumner, WA (US); Matthew S. Tillman, Lynnwood, WA (US); Rick G. Wire, Bonney Lake, WA (US)

Correspondence Address: BLACK LOWE & GRAHAM, PLLC, 701 FIFTH AVENUE, SUITE 4800, SEATTLE, WA, 98104, US

(21) Appl. No.: 10/751,303

(22) Filed: Jan. 2, 2004

Related U.S. Application Data
(63) Continuation-in-part of application No. 10/143,391, filed on May 9, 2002, now abandoned.

(51) Int. Cl. B05D 5/10; B05D 3/02; B05D 1/36; C23F 1/00

(52) U.S. Cl. 216/89; 427/384; 427/207.1; 427/307; 427/402

(57) ABSTRACT

Apparatus and process for continuous surface preparation of metal materials. The metal material is grit blasted with a mixture of fine particles of aluminum oxide in air and water. The metal material is rinsed with water to remove the grit. The metal material is subjected to a caustic solution of sodium hydroxide and then rinsed with water to remove the caustic solution of sodium hydroxide. A sol-gel coating is applied to the metal material and the water portion of the sol-gel coating is evaporated. A liquid adhesive coating is applied to the sol-gel coating on the metal material and the solvent portion of the adhesive coating is evaporated.

### FIELD OF THE INVENTION

This invention relates generally to metal surface treatments and, more specifically, to a continuous surface preparation of metals.

### BACKGROUND OF THE INVENTION

Metal treatment prior to bonding is a key factor for both the initial adhesion of a bond and its long-term durability in aircraft, aerospace, and other applications. Current metal prebond surface preparations are either inconvenient or complex to use, contain hazardous materials (strong acids, hexavalent chromium, volatile organic compounds), and/or do not provide the performance necessary for successful long-term durable bonds. Past bond failures, primarily due to inadequate surface preparation, have been a limiting factor in the current use of bonded hardware, especially for primary structure.

In particular, the bonding of titanium using standard surface preparation techniques has not always been an easy or reproducible process. The very passive nature of titanium and the difficulty involved in chemical processing of titanium alloys have minimized the use of bonded titanium parts for primary or secondary structure. Several programs have used titanium bonding successfully; however, the surface preparation techniques employed are often arduous and involve hazardous chemicals and processes.

Therefore, there is an unmet need in the art for an economical and environmentally sound continuous surface preparation process for titanium and other metals such as aluminum, stainless steel, nickel, and copper prior to bonding with other materials.

### SUMMARY OF THE INVENTION

Embodiments of the present invention provide continuous surface preparation processes for titanium, aluminum, stainless steel, nickel, and copper. The processes of the present invention provide for surface treatment of metals in economical and environmentally-friendly manners.

According to an embodiment of the present invention, a continuous process removes oxides from titanium, aluminum, stainless steel, nickel, and copper by grit blasting the metal with a mixture of fine particles of aluminum oxide in air and water. The metal is rinsed with water to remove the grit from the metal.

In accordance with an aspect of the invention, a continuous process applies a sol-gel coating to a metal material by subjecting the material to a caustic solution of sodium hydroxide. The material is rinsed with water to remove the caustic solution of sodium hydroxide. A sol-gel coating is applied to the metal and the water portion of the sol-gel coating is evaporated.

In accordance with another aspect of the invention, a continuous process applies an adhesive coating on to a sol-gel coating on a metal material by applying a liquid adhesive coating to the sol-gel coating on the metal. The solvent portion of the adhesive coating is evaporated.

In accordance with yet another aspect of the invention, a continuous surface preparation process for metal material grit blasts the metal with a mixture of fine particles of aluminum oxide in air and water. The metal is rinsed with water to remove the grit. The metal material is subjected to a caustic solution of sodium hydroxide and the metal is rinsed with water to remove the caustic solution of sodium hydroxide. A sol-gel coating is applied to the metal and the water portion of the sol-gel coating is evaporated. A liquid adhesive coating is applied to the sol-gel coating on the metal and the solvent portion of the adhesive coating is evaporated.

### BRIEF DESCRIPTION OF THE DRAWINGS

The preferred embodiments of the present invention are described in detail below with reference to the following drawings.

FIG. 1 is a schematic illustration of a grit blast line;

FIG. 2 is a schematic illustration of a sol-gel coating line; and

FIG. 3 is a schematic illustration of an adhesive coating line.

### DETAILED DESCRIPTION OF THE INVENTION

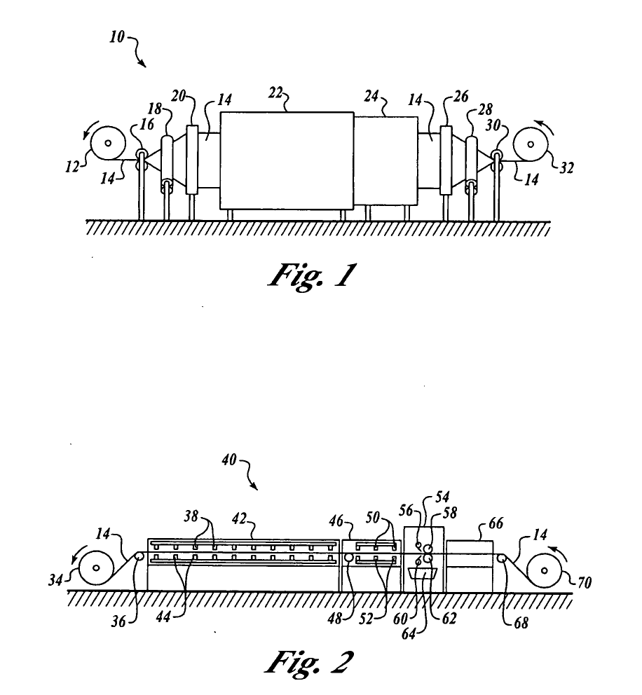

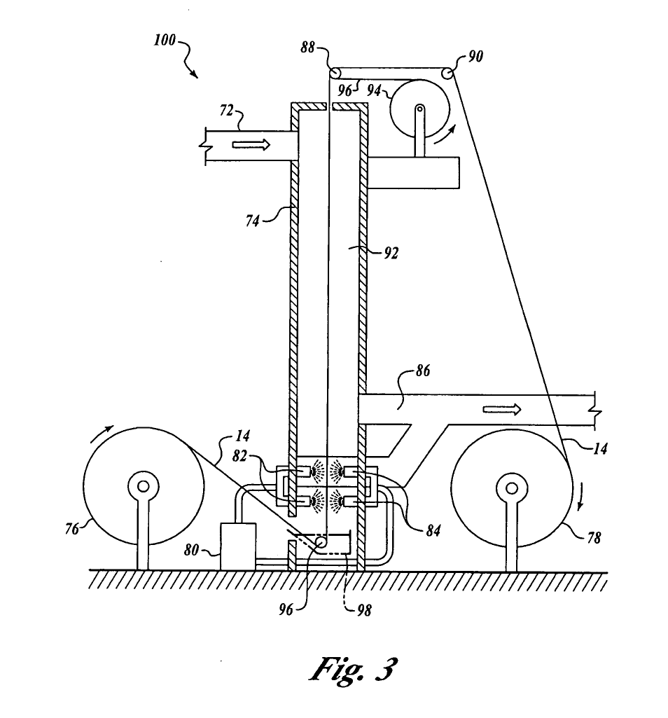

The present invention provides a continuous surface preparation process for metals such as titanium, aluminum, stainless steel, nickel, and copper. The term “metals” as used herein includes alloys. The process of the present invention may be utilized in the overall process of forming titanium/graphite (TiGr) laminate structures. By way of overview and with reference to FIGS. 1, 2, and 3 one presently preferred embodiment of the present invention includes a process including a grit blast line 10 (FIG. 1), a sol-gel coating line 40 (FIG. 2), and an adhesive coating line 70 (FIG. 3). It is to be understood that it is an aspect of the present invention to combine the three separate lines 10, 40, and 70 into a single continuous line if desired. Specific details of the process are described with more detail below.

Metal material 14 in FIG. 1 is selected from the group of titanium, aluminum, stainless steel, nickel, and copper. For example, material 14 may be a foil of the titanium alloy Ti-15V-3Cr-3Al-3Sn, and is suitably from about 0.002 to about 0.016 inches thick. Grit blast line 10 performs grit blasting of both sides of material 14 inside wet hone chamber 22 which houses oscillating grit blaster nozzles which expel a mixture of fine particles of aluminum oxide (alumina) in air and water. The grit has a mesh size of about 180-320 with a preferred mesh size of about 280. Material 14 is unwound from coil 12 and wound on coil 32. Material 14 travels through grit blast line 10 at a rate of about 5-10 feet per minute with a preferred rate of about 7.5 feet per minute. The wet hone process removes the oxide layer from both sides of material 14. Material 14 is tilted from a horizontal orientation to a vertical orientation by tilt rollers 16, 18, 20 before entering wet hone chamber 22.

A multiple stage water rinse is performed at ambient temperature in rinse chamber 24 to remove any grit on the material. An air curtain (not shown) at the exit side of chamber 24 blows high pressure air across both sides of material 14 to dry it. At the right end of line 10, material 14 is tilted back to a horizontal orientation from a vertical orientation by tilt rollers 26, 28, 30. Material 14 is then wound onto coil 32.

The coil is transported to sol-gel line 40 shown in FIG. 2. The coil is now designated as coil 34 for purposes of clarity. In FIG. 2, material 14 is unwound from coil 34 over rollers 36, 48, and 68 and wound on coil 70. Material 14 travels through sol-gel line 40 at a rate of about 3-7 feet per minute with a preferred rate of about 5 feet per minute. In caustic conditioner chamber 42, material 14 is subjected to a concentrated caustic solution of sodium hydroxide that is applied by upper spray heads 38 and lower spray heads 44. The concentration of the caustic solution is about 10-50% by weight sodium hydroxide with a preferred concentration of about 25% by weight sodium hydroxide. The temperature of the caustic solution is about 150-220° F. with a preferred temperature of about 190° F. The purpose of the caustic conditioner is to form a controlled layer of metal oxy-hydroxide on both surfaces of material 14. The oxy-hydroxide layer is needed for sufficient chemical bonding to the subsequent sol-gel coating in chamber 54.

The caustic solution is washed off material 14 inside rinse chamber 46 using warm water applied by upper spray heads 50 and lower spray heads 52. Squeegees (not shown) inside rinse chamber 46 dry off the bulk of the rinse water. In sol-gel coating chamber 54, the water-based sol-gel solution is sprayed on material 14 by spray nozzles 56 and 60. The sol-gel materials are fully described in U.S. patent application Ser. No. 10/143,375 filed May 9, 2002, U.S. Pat. No. 5,814,137 issued Sep. 29, 1998, U.S. Pat. No. 5,849,110 issued Dec. 15, 1998, U.S. Pat. No. 5,869,141 issued Feb. 9, 1999, U.S. Pat. No. 5,939,197 issued Aug. 17, 1999, U.S. Pat. No. 5,958,578, and U.S. Pat. No. 6,037,060 issued Mar. 14, 2000, all of which are incorporated by reference herein.

For example, the sol-gel may be an aqueous mixture of a zirconium alkoxide such as zirconium n-propoxide, 3-glycidoxy-propyltrimethoxysilane, glacial acetic acid, and a surfactant. The surfactant is suitably Antarox BL-240 made by Rhodia Inc. of Cranbury, N.J. 08512-7500. However, other surfactants are considered within the scope of this invention, such as, without limitation, Tomadol 91-8 made by Tomah3 Products, Inc. of Milton, Wis. 53563-0388.

Metering rollers 58 and 62 skim off excess sol-gel solution on the surfaces of material 14. The wet sol-gel layer is about 1-5 mils thick before drying, with a preferred thickness of about 2.5 mils. The excess sol-gel solution falls into collecting pan 64. Material 14 travels into oven 66 where the water portion of the sol-gel is evaporated off. As dried, the sol-gel layer is about 10-500 nm thick, with a preferred thickness of about 100 nm. The temperature in oven 66 is about 150° F. Material 14 is wound on coil 70.

The coil is transported to adhesive line 100 shown in FIG. 3. The coil is now designated as coil 76 for purposes of clarity. In FIG. 3, material 14 is unwound from coil 76 over rollers 96, 88, and 90 and wound on coil 78. Material 14 travels into the bottom of two-part chamber 74. The lower part is the adhesive coating section and the upper part is an oven section 92. In the coating section, two methods of applying the adhesive are illustrated. One method is the adhesive dip-coating tank 98 shown in phantom at the bottom. The other method shown in FIG. 3 uses spray nozzles 82 and 84 to spray on the adhesive coating. Other methods of applying the adhesive may be employed such as graveure coating and reverse roller coating. The dry adhesive coating is also known as an interphase coating and has a thickness of 0.1 to 3.0 mils with a preferred thickness of 0.75 mils. The adhesive coating should have a uniform, consistent thickness.

The adhesive material is fully described in U.S. patent application Ser. No. 10/143,375 filed May 9, 2002 which is incorporated herein by reference. In a presently preferred embodiment, the epoxy-based adhesive coating includes a first epoxy material including approximately 25% solids by weight and a second curative material including approximately 32% solids by weight. The first epoxy material suitably includes about 3% to about 35% by weight liquid diglycidylether of bisphenol-A, about 35% to about 60% by weight solid diglycidylether of bisphenol-A, about 10% to about 30% by weight novolac-epoxy, and about 5% to about 18% by weight solid carboxy-terminated acrylonitrile-butadiene rubber, and the second curative material suitably includes about 0% to about 100% by weight 4,4′-diaminodiphenylsulfone, about 0% to about 100% by weight 3,3′-diaminodiphenylsulfone, and about 0% to about 0.2% by weight chromium octotate. An organic solvent, such as acetone, is used to dissolve the adhesive.

Material 14 travels upwardly through oven section 92 where the solvent is evaporated off. The temperature in oven 75 is about 150-170° F. with a preferred temperature of about 160° F. Heated air is supplied to oven 75 through inlet duct 72 and the solvent vapor exits through exhaust duct 86.

As material 14 passes over roller 88, a backing film 96 from coil 94 is applied to material 14. Backing film 96 prevents the coated material from sticking to itself. The preferred backing film is thermoplastic film made of polyethylene terphthalate (PET) having a thickness of about 4 mils. Material 14 is wound on coil 78. Coil 78 has uncured epoxy material on the material surfaces, therefore it must be stored in a freezer until the further manufacturing steps (for example, laying down a composite layer and doing the lamination) are ready to be undertaken.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A continuous process for removing oxides from a metal material, the process comprising:
grit blasting the metal material with a mixture of fine particles of aluminum oxide in air and water, wherein the grit has a mesh size of about 180-320; and
rinsing the metal material with water to remove the grit.

2. The process of claim 1, wherein the grit has a mesh size of about 280.

3. The process of claim 1, wherein the metal material is selected from the group consisting of titanium, aluminum, stainless steel, nickel, and copper.

4. A continuous process for applying a sol-gel coating to a metal material, the process comprising:
subjecting the metal material to a caustic solution of sodium hydroxide;
rinsing the metal material with water to remove the caustic solution of sodium hydroxide from the metal material;
applying a sol-gel coating to the metal material; and
evaporating the water portion of the sol-gel coating.

5. The process of claim 4, wherein the metal material is selected from the group consisting of titanium, aluminum, stainless steel, nickel, and copper.

6. The process of claim 4, wherein the caustic solution of sodium hydroxide has a concentration of about 10-50% by weight sodium hydroxide.

7. The process of claim 4, wherein the caustic solution of sodium hydroxide has a concentration of about 25% by weight sodium hydroxide.

8. The process of claim 4, wherein the temperature of the caustic solution is about 150-220° F.

9. The process of claim 4, wherein the temperature of the caustic solution is about 190° F.

10. The process of claim 4, wherein dry sol-gel layer is about 10-500 nm thick.

11. The process of claim 4, wherein the dry sol-gel layer is about 100 nm thick.

12. The process of claim 4, wherein the sol-gel is a mixture of a zirconium alkoxide, 3-glycidoxy-propyltrimethoxysilane, glacial acetic acid, and a surfactant.

13. The process of claim 4, wherein the sol-gel is a mixture of zirconium n-propoxide, 3-glycidoxy-propyltrimethoxysilane, glacial acetic acid, and a surfactant

14. The process of claim 13, wherein the surfactant is Antarox BL-240.

15. The process of claim 13, wherein the surfactant is Tomadol 91-8.

16. A continuous process for applying an adhesive coating onto a sol-gel coating on a metal material, the process comprising:
applying a liquid adhesive coating to the sol-gel coating on the metal material; and
evaporating the solvent portion of the adhesive coating.

17. The process of claim 16, wherein the metal material is selected from the group consisting of titanium, aluminum, stainless steel, nickel, and copper.

18. The process of claim 16 wherein the liquid adhesive coating is applied in a dip-coating tank.

19. The process of claim 16 wherein the liquid adhesive coating is applied by spraying.

20. The process of claim 16 wherein the dry adhesive coating has a thickness of 0.1 to 3.0 mils.

21. The process of claim 20 wherein the dry adhesive coating has a thickness of 0.75 mils.

22. The process of claim 16 wherein the liquid adhesive coating is an epoxy-based adhesive coating comprising:
an epoxy material comprising about 3-35% by wt. diglycidylether of bisphenol-A, about 35-60% by wt. diglycidylether of bisphenol-A, about 10-30% by wt. novolac-epoxy, and about 5-18% by wt. carboxy-terminated acrylonitrile-butadiene rubber; and
a second curative material comprising about 0-100% by wt. 4,4′-diaminodiphenylsulfone, about 0-100% by wt. 3,3′-diaminodiphenylsulfone, and about 0-0.2% by wt. chromium octotate.

23. The process of claim 22 wherein acetone is used as the solvent for the adhesive.

24. A continuous surface preparation process for a metal material comprising:
grit blasting the metal material with a mixture of fine particles of aluminum oxide in air and water, wherein the grit has a mesh size of about 180-320;
rinsing the metal material with water to remove the grit;
subjecting the metal material to a caustic solution of sodium hydroxide;
rinsing the metal material with water to remove the caustic solution of sodium hydroxide;
applying a sol-gel coating to the metal material;
evaporating the water portion of the sol-gel coating;
applying a liquid adhesive coating to the sol-gel coating on the metal material; and
evaporating the solvent portion of the adhesive coating.

25. The process of claim 24, wherein the metal material is selected from the group consisting of titanium, aluminum, stainless steel, nickel, and copper.

26. The process of claim 24 wherein the grit has a mesh size of about 280.

27. The process of claim 24 wherein the caustic solution of sodium hydroxide has a concentration of about 10-50% by weight sodium hydroxide.

28. The process of claim 26 wherein the caustic solution of sodium hydroxide has a concentration of about 25% by weight sodium hydroxide.

29. The process of claim 24 wherein the temperature of the caustic solution is about 150-220° F.

30. The process of claim 24 wherein the temperature of the caustic solution is about 190° F.

31. The process of claim 24 wherein the dry sol-gel layer is about 10-500 nm thick.

32. The process of claim 24 wherein the dry sol-gel layer is about 100 nm thick.

33. The process of claim 24 wherein the sol-gel is a mixture of a zirconium alkoxide, 3-glycidoxy-propyltrimethoxysilane, glacial acetic acid, and a surfactant.

34. The process of claim 24 wherein the sol-gel is a mixture of zirconium n-propoxide, 3-glycidoxy-propyltrimethoxysilane, glacial acetic acid, and a surfactant.

35. The process of claim 33 wherein the surfactant is Antarox BL-240.

36. The process of claim 33 wherein the surfactant is Tomadol 91-8.

37. The process of claim 24 wherein the liquid adhesive coating is applied in a dip-coating tank.

38. The process of claim 24 wherein the liquid adhesive coating is applied by spraying.

39. The process of claim 24 wherein the dry adhesive coating has a thickness of 0.1 to 3.0 mils.

40. The process of claim 24 wherein the dry adhesive coating has a thickness of 0.75 mils.

41. The process of claim 24 wherein the liquid adhesive coating is an epoxy-based adhesive coating including:
an epoxy material comprising about 3-35% by wt. diglycidylether of bisphenol-A, about 35-60% by wt. diglycidylether of bisphenol-A, about 10-30% by wt. novolac-epoxy, and about 5-18% by wt. carboxy-terminated acrylonitrile-butadiene rubber; and
a second curative material comprising about 0-100% by wt. 4,4′-diaminodiphenylsulfone, about 0-100% by wt. 3,3′-diaminodiphenylsulfone, and about 0-0.2% by wt. chromium octotate.

42. The process of claim 40 wherein acetone is used as the solvent for the adhesive.

43. A continuous surface preparation process for a metal material, said process comprising:
grit blasting the metal material with a mixture of fine particles of aluminum oxide in air and water, wherein the grit has a mesh size of about 180-320;
rinsing the metal material with water to remove the grit;
subjecting the metal material to a caustic solution of sodium hydroxide wherein the caustic solution of sodium hydroxide has a concentration of about 10-50% by weight sodium hydroxide;
rinsing the metal material with water to remove the caustic solution of sodium hydroxide from the metal material;
applying a sol-gel coating to the metal material wherein the sol-gel is a mixture of a zirconium alkoxide, 3-glycidoxy-propyltrimethoxysilane, glacial acetic acid, and a surfactant;
evaporating the water portion of the sol-gel coating;
applying a liquid adhesive coating to the sol-gel coating on the metal material wherein the liquid adhesive coating is an epoxy-based adhesive coating including:
an epoxy material comprising about 3-35% by wt. diglycidylether of bisphenol-A, about 35-60% by wt. diglycidylether of bisphenol-A, about 10-30% by wt. novolac-epoxy, and about 5-18% by wt. carboxy-terminated acrylonitrile-butadiene rubber; and
a second curative material comprising about 0-100% by wt. 4,4′-diaminodiphenylsulfone, about 0-100% by wt. 3,3′-diaminodiphenylsulfone, and about 0-0.2% by wt. chromium octotate; and
evaporating the solvent portion of the adhesive coating.

44. The process of claim 43, wherein the metal material is selected from the group consisting of titanium, aluminum, stainless steel, nickel, and copper.

45. A continuous surface preparation process for titanium foil material, said process comprising:
grit blasting the titanium foil with a mixture of fine particles of aluminum oxide in air and water, wherein the grit has a mesh size of about 280;
rinsing the foil with water to remove the grit from the foil;
subjecting the foil material to a caustic solution of sodium hydroxide wherein the caustic solution of sodium hydroxide has a concentration of about 25% by weight sodium hydroxide;
rinsing the foil with water to remove the caustic solution of sodium hydroxide from the foil;
applying a sol-gel coating to the foil wherein the sol-gel is a mixture of a zirconium n-propoxide 3-glycidoxy-propyltrimethoxysilane, glacial acetic acid, and a surfactant;
evaporating the water portion of the sol-gel coating;
applying a liquid adhesive coating to the sol-gel coating on the foil 21 wherein the liquid adhesive coating is an epoxy-based adhesive coating including:
an epoxy material comprising about 3-35% by wt. diglycidylether of bisphenol-A, about 35-60% by wt. diglycidylether of bisphenol-A, about 10-30% by wt. novolac-epoxy, and about 5-18% by wt. carboxy-terminated acrylonitrile-butadiene rubber; and
a second curative material comprising about 0-100% by wt. 4,4′-diaminodiphenylsulfone, about 0-100% by wt. 3,3′-diaminodiphenylsulfone, and about 0-0.2% by wt. chromium octotate; and
evaporating the solvent portion of the adhesive coating.

46. The process of claim 45, wherein the metal material is selected from the group consisting of titanium, aluminum, stainless steel, nickel, and copper.

47. The product made by the process of claim 1.

48. The product made by the process of claim 4.

49. The product made by the process of claim 16.

50. The product made by the process of claim 24.

51. The product made by the process of claim 43.

52. The product made by the process of claim 45.

53. Apparatus for continuously removing the oxide layer from a metal material, the apparatus comprising:
tilt rollers for continuously tilting the metal material from a horizontal orientation to a vertical orientation;
a wet hone chamber for continuously grit blasting the metal material with a mixture of fine particles of aluminum oxide in air and water;
a multiple stage water rinse chamber for continuously removing grit from the metal material; and
tilt rollers for continuously tilting the metal material back to a horizontal orientation from a vertical orientation.

54. Apparatus for continuously applying a sol-gel coating to metal material, the apparatus comprising:
a caustic conditioner chamber for continuously subjecting the metal material to a caustic solution of sodium hydroxide;
a rinse camber for continuously rinsing the metal material with water to remove the caustic solution of sodium hydroxide;
a sol-gel coating chamber for continuously applying a sol-gel coating to the metal material; and
an oven for continuously evaporating the water portion of the sol-gel coating.

55. Apparatus for continuously applying an adhesive coating onto a sol-gel coating on a metal material, the apparatus comprising:
an adhesive coating section for continuously applying a liquid adhesive coating to the sol-gel coating on the metal material; and
an oven section for continuously evaporating the solvent portion of the adhesive coating.

56. The apparatus of claim 55, wherein adhesive coating section comprises a dip-coating tank.

57. The apparatus of claim 55, wherein adhesive coating section comprises spray nozzles.

58. Apparatus for continuously preparing the surface of metal material, said apparatus comprising:
tilt rollers for continuously tilting the metal material from a horizontal orientation to a vertical orientation;
a wet hone chamber for continuously grit blasting the metal material with a mixture of fine particles of aluminum oxide in air and water;
a multiple stage water rinse chamber for continuously removing grit from the metal material;
tilt rollers for continuously tilting the metal material back to a horizontal orientation from a vertical orientation;
a caustic conditioner chamber for continuously subjecting the metal material to a caustic solution of sodium hydroxide;
a rinse camber for continuously rinsing the metal material with water to remove the caustic solution of sodium hydroxide;
a sol-gel coating chamber for continuously applying a sol-gel coating to the metal material;
an oven for continuously evaporating the water portion of the sol-gel coating;
an adhesive coating section for continuously applying a liquid adhesive coating to the sol-gel coating on the metal material; and
an oven section for continuously evaporating the solvent portion of the adhesive coating.

59. The apparatus of claim 58, wherein adhesive coating section comprises a dip-coating tank.

60. The apparatus of claim 58, wherein adhesive coating section comprises spray nozzles.
